(19) United States
(12) Patent Application Publication
(10) Pub. No.: US 2014/0199475 A1
(43) Pub. Date: Jul. 17, 2014

(54) POSITIVE ELECTRODE ACTIVE MATERIAL FOR LITHIUM SECONDARY BATTERY AND PRODUCTION METHOD OF SAME

(71) Applicant: SHOWA DENKO K.K., Tokyo (JP)

(72) Inventors: Akihisa TONEGAWA, Yokohama-shi (JP); Akihiko SHIRAKAWA, Chiba-shi (JP); Isao KABE, Yokohama-shi (JP); Gaku ORIJI, Kawasaki-shi (JP)

(73) Assignee: SHOWA DENKO K.K., Tokyo (JP)

(21) Appl. No.: 14/217,995

(22) Filed: Mar. 18, 2014

Related U.S. Application Data
(63) Continuation of application No. PCT/JP2012/074543, filed on Sep. 25, 2012.

(30) Foreign Application Priority Data
Sep. 29, 2011 (JP) 2011-214368

(51) Int. Cl. C01B 25/16

(52) U.S. Cl. CPC C01B 25/16
USPC 427/122; 427/126.1

(57) ABSTRACT

A positive electrode active material for a lithium secondary battery having a core portion and a shell layer is employed in which the core portion is represented by Lix₁M1y₁Pz₁O₄ (where, M1 represents an element such as Mg, Ca, Fe or Mn, and the letters x₁, y₁ and z₁ representing composition ratios are respectively such that 0<x₁<2, 0<y₁<1.5 and 0.9<z₁<1.1), the shell layer is composed of one or more layers represented by Lix₂M2y₂Pz₂O₄ (where, M2 represents one type or two or more types of elements selected from the group consisting of Mg, Fe, Ni, Co and Al, and the letters x₂, y₂ and z₂ representing composition ratios are respectively such that 0<x₂<2, 0<y₂<1.5 and 0.9<z₂<1.1).

This application is a continuation application based on a PCT Patent Application No. PCT/JP2012/074543, filed Sep. 25, 2012, whose priority is claimed on Japanese Patent Application No. 2011-214368, filed Sep. 29, 2011. The contents of both the PCT application and the Japanese Patent Application are incorporated herein by reference.

### TECHNICAL FIELD

The present invention relates to a positive electrode active material for a lithium secondary battery and a production method thereof.

### BACKGROUND ART

Since LiMPO₄ (wherein, M represents a metal such as Fe or Mn), which is an olivine-type of lithium metal phosphate, is less expensive than LiCoO₂, which has conventionally been widely used as a positive electrode active material of lithium secondary batteries, this material is expected to be used in the future as a positive electrode active material of lithium secondary batteries, and particularly large-sized lithium secondary batteries for automotive use. In addition, among lithium metal phosphates represented by LiMPO₄, LiFePO₄ is known to have favorable cycle characteristics (Patent Document 1).

As is described in Patent Documents 2 and 3 and Non-Patent Documents 1 and 2, known examples of methods used to produce LiMPO₄ include solid-phase synthesis, hydrothermal synthesis and sol-gel methods. Among these, hydrothermal synthesis is superior since it allows the obtaining of LiMPO₄ having a small particle diameter at a comparatively low temperature and in a short period of time.

Patent Document 4 discloses a lithium metal composite phosphate compound having a core-shell structure that uses a material having comparatively favorable cycle characteristics for the shell portion as a means of improving cycle characteristics of lithium metal composite phosphate compounds.

### DOCUMENT OF RELATED ART

### Patent Documents

[Patent Document 1] Canadian Patent No. 2320661
[Patent Document 2] International Publication No. WO 97/040541
[Patent Document 3] International Publication No. WO 05/051840
[Patent Document 4] Japanese Unexamined Patent Application Publication (Translation of PCT Application) No. 2011-502332

### Non-Patent Documents

[Non-Patent Document 1] Chemistry Letters, 36 (2007), 436
[Non-Patent Document 2] Electrochemical and Solid-State Letters, 9 (2006), A277-A280

### SUMMARY OF INVENTION

### Technical Problem

However, in Patent Document 4, since the shell layer is formed by a dry coating method after having formed the core particles, there was the problem of low adhesion between the core portion and the shell portion.

With the foregoing in view, an object of the present invention is to provide a positive electrode active material for a lithium secondary battery having superior adhesion between core particles and the shell layer, and a production method thereof.

### Solution to Problem

[1] A positive electrode active material for a lithium secondary battery having a core portion and a shell layer, wherein:

the core portion is an olivine-type lithium metal phosphate represented by Lix₁M1y₁Pz₁O₄ (where, M1 represents one type or two or more types of elements selected from the group consisting of Mg, Ca, Fe, Mn, Ni, Co, Zn, Ge, Cu, Cr, Ti, Sr, Ba, Sc, Y, Al, Ga, In, Si, B and rare earth elements, and the letters x₁, y₁ and z₁ representing composition ratios are respectively such that 0<x₁<2, 0<y₁<1.5 and 0.9<z₁<1.1); and

the shell layer is composed of one or more layers composed of an olivine-type lithium metal phosphate represented by Lix₂M2y₂Pz₂O₄ (where, M2 represents one type or two or more types of elements selected from the group consisting of Mg, Fe, Ni, Co and Al, and the letters x₂, y₂ and z₂ representing composition ratios are respectively such that 0<x₂<2, 0<y₂<1.5 and 0.9<z₂<1.1).

[2] The positive electrode active material for a lithium secondary battery described in [1], wherein the rate of increase of specific surface area when put into the form of a core-shell structure is within 10% of the specific surface area of the core portion.

[3] The positive electrode active material for a lithium secondary battery described in [1] or [2], wherein a carbon material is adhered to the surface of the shell layer.

[4] A method for producing a positive electrode active material for a secondary lithium battery having a core portion and a shell layer, comprising:

a first step for obtaining a reaction liquid containing a core portion composed of an olivine-type lithium metal phosphate represented by Lix₁M1y₁Pz₁O₄ (where, M1 represents one type or two or more types of elements selected from the group consisting of Mg, Ca, Fe, Mn, Ni, Co, Zn, Ge, Cu, Cr, Ti, Sr, Ba, Sc, Y, Al, Ga, In, Si, B and rare earth elements, and the letters x₁, y₁ and z₁ representing composition ratios are respectively such that 0<x₁<2, 0<y₁<1.5 and 0.9<z₁<1.1), an excess Li source and an excess phosphoric acid source by using an M1 source, an excess amount of the Li source with respect to the M1 source and an excess amount of the phosphoric acid source with respect to the M1 source for a first raw material, and carrying out a hydrothermal synthesis reaction using the first raw material; and

a second step for carrying out at least once a step for forming a shell layer composed of an olivine-type lithium metal phosphate represented by Lix₂M2y₂Pz₂O₄ (where, M2 represents one type or two or more types of elements differing from M1 selected from the group consisting of Mg, Fe, Ni, Co and Al, and the letters x₂, y₂ and z₂ representing composition ratios are respectively such that 0<x₂<2, 0<y₂<1.5 and 0.9<z₂<1.1) on the core portion by adding an M2 source to the reaction liquid, using the excess Li source, excess phosphoric acid source and M2 source as a second raw material, and carrying out a hydrothermal synthesis reaction using the second raw material.

[5] The method for producing a positive electrode active material for a lithium secondary battery described in [4], wherein the hydrothermal synthesis reaction in the first step and in the second step is respectively carried out at 100° C. or higher, and the temperature of the reaction liquid between the first step and the second step is maintained at 100° C. or higher.

[6] The method for producing a positive electrode active material for a lithium secondary battery described in [4] or [5], wherein the M1 source is one type or two or more types selected from the group consisting of a sulfate, halide salt, nitrate, phosphate and organic salt of an M1 element, and

the M2 source is one type or two or more types selected from the group consisting of a sulfate, halide salt, nitrate, phosphate and organic salt of an M2 element.

[7] The method for producing a positive electrode active material for a lithium secondary battery described in any of [4] to [6], wherein the Li source is one type or two or more types selected from the group consisting of LiOH, Li₂CO₃, CH₃COOLi and (COOLi)₂.

[8] The method for producing a positive electrode active material for a lithium secondary battery described in any of [4] to [7], wherein the phosphoric acid source is one type or two or more types selected from the group consisting of H₃PO₄, HPO₃, (NH₄)₃PO₄, (NH₄)₂PO₄, NH₄H₂PO₄ and organic phosphates.

[9] A method for producing a positive electrode active material for a lithium secondary battery, wherein a carbon material is adhered to the surface of the shell layer by mixing a carbon source with the positive electrode active material for a lithium secondary battery obtained according to the production method described in any of [4] to [8], and heating this mixture in an inert gas atmosphere or reducing atmosphere.

[10] The method for producing a positive electrode active material for a lithium secondary battery described in [9], wherein one or more types of any of sucrose, lactose, ascorbic acid, 1,6-hexanediol, polyethylene glycol, polyethylene oxide, carboxymethyl cellulose, carbon black and filamentous carbon are used as the carbon source.

### Effects of the Invention

According to the present invention, since a positive electrode active material for a secondary lithium battery having superior adhesion between a core portion and a shell layer, and a production method thereof, can be provided, a positive electrode active material is provided that demonstrates superior battery characteristics.

### BRIEF DESCRIPTION OF DRAWINGS

FIG. 1 depicts an X-ray diffraction pattern of a positive electrode active material of Example 1.

FIG. 2 is an SEM micrograph of a positive electrode active material of Example 1.

FIG. 3 is an SEM micrograph of a positive electrode active material of Comparative Example 3.

FIG. 4 depicts images generated by STEM-EDS mapping of a positive electrode active material of Example 1.

### DESCRIPTION OF EMBODIMENTS

A preferable method for producing a positive electrode active material for a lithium secondary battery of the present embodiment comprises a first step for obtaining a reaction liquid containing a core portion represented by Lix₁M1y₁Pz₁O₄, an excess Li source and an excess phosphoric acid source by using an M1 source, an excess amount of the Li source with respect to the M1 source and an excess amount of the phosphoric acid source with respect to the M1 source for a first raw material, and carrying out a hydrothermal synthesis reaction using the first raw material; and a second step for carrying out at least once a step for forming a shell layer represented by Lix₂M2y₂Pz₂O₄ on the core portion in the reaction liquid obtained in the first step by adding an M2 source to the reaction liquid obtained in the first step to obtain a second raw material, and carrying out a hydrothermal synthesis reaction using the second raw material. The following provides a sequential explanation of each step.

[First Step]

In the first step, a reaction liquid containing a core portion composed of an olivine-type lithium metal phosphate represented by Lix₁M1y₁Pz₁O₄ is obtained by using an M1 source, an excess Li source with respect to the M1 source and an excess phosphoric acid source with respect to the M1 source as a first raw material and carrying out a hydrothermal synthesis reaction on the first raw material. During the hydrothermal synthesis reaction, the Li source and the phosphoric acid source added in excess are contained in the reaction liquid as an excess Li source and excess phosphoric acid source.

(M1 Source)

The M1 source that composes the first raw material is a compound that melts during hydrothermal synthesis, and although it can be selected arbitrarily, it is preferably a compound containing one type or two or more types of M1 elements selected from the group consisting of Mg, Ca, Fe, Mn, Ni, Co, Zn, Ge, Cu, Cr, Ti, Sr, Ba, Sc, Y, Al, Ga, In, Si, B and rare earth elements. Among these, compounds containing divalent transition metals are particularly preferable, and examples of divalent transition metals include one type or two or more types of any of Fe, Mn, Ni or Co, while more preferable examples are Fe and/or Mn. Examples of M1 sources include sulfates, halides (such as chlorides, fluorides, bromides or iodides), nitrates, phosphates and organic acid salts (such as oxalates or acetates) of the M1 element. The M1 source is also preferably a compound that easily dissolves in the solvent used in the hydrothermal synthesis reaction. Among these, divalent transition metal sulfates are preferable, and iron (II) sulfate and/or manganese (II) sulfate as well as hydrates thereof are more preferable. Since Lix₁M1y₁Pz₁O₄ containing any of these M1 elements has a high charge-discharge capacity, containing Lix₁M1y₁Pz₁O₄ in a positive electrode active material as a core portion thereof makes it possible to improve charge-discharge capacity of the positive electrode active material.

(Li Source)

Although the Li source that composes the first raw material can be selected arbitrarily, it is preferably a compound that melts during hydrothermal synthesis, and examples thereof include one type or two or more types of any of LiOH, Li₂CO₃, CH₃COOLi and (COOLi)₂. Among those compounds that melt during hydrothermal synthesis, LiOH is preferable.

(Phosphoric Acid Source)

The phosphoric acid source that composes the first raw material is only required to be that which contains a phosphate ion, and is preferably a compound that easily dissolves in a polar solvent. Examples thereof include phosphoric acid (orthophosphoric acid (H₃PO₄)), metaphosphoric acid (HPO₃), pyrophosphoric acid, triphosphoric acid, tetraphosphoric acid, hydrogen phosphate, dihydrogen phosphate, ammonium phosphate, anhydrous ammonium phosphate ((NH₄)₃PO₄), ammonium dihydrogen phosphate (NH₄H₂PO₄), diammonium hydrogen phosphate ((NH₄)₂HPO₄), lithium phosphate, iron phosphate and organic phosphates.

In addition, water may also be added to the first raw material. Crystalline water contained each compound of the Li source, M1 source or phosphoric acid source may be used for the water. If an adequate amount of crystalline water is contained in the compound of the M1 source or compound of the Li source, the Li source, M1 source and phosphoric acid source are mixed to obtain the first raw material, and water may intentionally not be added.

Furthermore, examples of polar solvents other than water that can be hydrothermally synthesized include methanol, ethanol, 2-propanol, ethylene glycol, propylene glycol, acetone, cyclohexanone, 2-methylpyrrolidone, ethyl methyl ketone, 2-ethoxyethanol, propylene carbonate, ethylene carbonate, dimethyl carbonate, dimethylformamide and dimethylsulfoxide. These solvents may be used alone in place of water or these solvents may be used after mixing with water.

The above substances constitute the main substances that compose the first raw material. The following substances may be further added for use as the first raw material other than these main substances that compose the first raw material.

A reducing substance such as ascorbic acid is a carbon source that can also be used as an antioxidant that prevents oxidation of raw materials during hydrothermal synthesis. Examples of such antioxidants other than ascorbic acid include tocopherol, dibutylhydroxytoluene, butylhydroxyanisole and propyl gallate. In addition, this reducing substance may also be mixed into the second raw material.

(First Raw Material Blending Ratio)

The blending ratio of the first raw material in the first step (each of the added amounts of the M1 source, Li source and phosphoric acid source) is normally sufficient to be such that the added amounts of the M1 source, Li source and phosphoric acid source satisfy the ratio of Li:M1 element:P=x₁:y₁:z₁ when represented as the molar ratio among the Li, M1 element and P in the case of obtaining a core portion having the composition of Lix₁M1y₁Pz₁O₄ (where, the letters x₁, y₁ and z₁ representing composition ratios are respectively such that 0<x₁<2, 0<y₁<1.5 and 0.9<z₁<1.1). In the present embodiment, the added amounts of the M1 source, Li source and phosphoric acid source are adjusted such that the molar ratios of Li and P are in excess with respect to x₁ and z₁. In the obtaining of a core portion having the composition of Lix₁M1y₁Pz₁O₄, as a result of adding the Li source and phosphoric acid source in excess with respect to the M1 source, an excess of the Li source and phosphoric acid source respectively remain in the reaction liquid following completion of the first step. The residual excess Li source and phosphoric acid source are then used as raw materials of the shell portion in the second step. Thus, the added amounts of the Li source and phosphoric acid source incorporated in the first raw material are determined based on the ratio between the core portion and the shell portion.

More specifically, in the case of taking the amount of the M1 source in the first raw material to be an amount corresponding to the composition ratio y₁, then the added amount of the Li source is preferably an amount corresponding to a range of greater than 1.00 times to 1.20 times the composition ratio x₁ of Li, more preferably an amount corresponding to a range of greater than 1.01 times to 1.18 times the composition ratio x₁ of Li, and even more preferably an amount corresponding to a range of greater than 1.05 times to 1.10 times the composition ratio x₁ of Li. If the added amount of the Li source is greater than 1.00 times the composition ratio x₁ of Li, there is no risk of a shortage of the Li source when forming the shell portion in the second step, thereby making this desirable. In addition, if the added amount of the Li source is 1.20 times or less the composition ratio x₁ of Li, the Li source is not added excessively, thereby making this preferable.

Similarly, in the case of taking the amount of the M1 source in the first raw material to be an amount corresponding to the composition ratio y₁, then the added amount of the phosphoric acid source is preferably an amount corresponding to a range of greater than 1.00 times to 1.20 times the composition ratio z₁ of P, more preferably an amount corresponding to a range of greater than 1.01 times to 1.18 times the composition ratio z₁ of P, and even more preferably an amount corresponding to a range of greater than 1.05 times to 1.10 times the composition ratio z₁ of P. If the added amount of the phosphoric acid source is greater than 1.00 times the composition ratio z₁ of P, there is no risk of a shortage of the phosphoric acid source when forming the shell portion in the second step, thereby making this desirable. In addition, if the added amount of the phosphoric acid source is 1.20 times or less the composition ratio z₁ of P, the phosphoric acid source is not added excessively, thereby making this desirable.

(Hydrothermal Synthesis Reaction in First Step)

In a preferable production method of the present embodiment, hydrothermal synthesis is carried out by reacting the Li source, M1 source and phosphoric acid source at 100° C. or higher. Here, since unexpected side reactions may proceed when the Li source, M1 source and phosphoric acid source are mixed simultaneously, it is necessary to control the progress of the reaction.

Thus, in the present production method, a first raw material liquid containing one type of any of a lithium source, phosphoric acid source or M1 source in a solvent, and a second raw material liquid containing raw materials not contained in the first raw material liquid are prepared separately, and together with mixing the first and second raw material liquids, a conversion reaction is initiated after setting the temperature and pressure to prescribed conditions.

Specific examples of preparing the first and second raw material liquids include an aspect in which a liquid containing an Li source is prepared for use as the first raw material liquid and a liquid containing an M1 source and phosphoric acid source is prepared for use as the second raw material liquid, an aspect in which a liquid containing a phosphoric acid source is prepared for use as the first raw material liquid and a liquid containing an M1 source and Li source is prepared for use as the second raw material liquid, and an aspect in which a liquid containing an M1 source is prepared for use as the first raw material liquid and a liquid containing a phosphoric acid source and an Li source is prepared for use as the second raw material liquid. The first raw material liquid and the second raw material liquid are prevented from contacting, and more specifically, the first raw material liquid and the second raw material liquid are prevented from mixing. In this manner, the conversion reaction is substantially prevented from occurring at a temperature below 100° C.

Next, the first and second raw material liquids are brought into contact, and a reaction for converting to Lix₁M1y₁Pz₁O₄ is initiated and allowed to proceed at 100° C. or higher.

The aforementioned reaction is carried out in a pressure-resistant vessel in the manner of an autoclave. When contacting the first and second raw material liquids, the first and second raw material liquids may or may not be preliminarily heated to about 60° C. to 100° C. After mixing the first and second raw material liquids in the pressure-resistant vessel, the vessel is sealed followed by immediately (within, for example, 1 to 2 hours) heating to 100° C. with the autoclave. The inside of the vessel is preferably replaced with an inert gas or reducing gas. Examples of inert gases include nitrogen and argon. Furthermore, although the heating temperature can be selected as necessary provided it is 100° C. or higher, it is preferably 160° C. to 280° C. and more preferably 180° C. to 200° C. In addition, although the pressure at this time can also be selected as necessary, it is preferably 0.6 MPa to 6.4 MPa and more preferably 1.0 MPa to 1.6 MPa.

Particles composed of Lix₁M1y₁Pz₁O₄ grow as a result of this conversion reaction. In this manner, a reaction liquid is obtained that is composed of a suspension containing the core portion according to the present embodiment. Excess Li source and phosphoric acid source are also contained in the resulting reaction liquid.

[Second Step]

Next, in the second step, an M2 source is mixed into a reaction liquid containing an excess Li source and an excess phosphoric acid source, the excess Li source, the excess phosphoric acid source and the M2 source are used as a second raw material, and a hydrothermal synthesis reaction is carried out on the second raw material. As a result of this reaction, a shell layer composed of an olivine-type lithium metal phosphate represented by Lix₂M2y₂Pz₂O₄ is formed on the surface of the core portion.

(M2 Source)

Although the M2 source that composes the second raw material can be selected arbitrarily, it is preferably a compound that melts during hydrothermal synthesis and contains one type or two or more types of elements differing from the aforementioned M1 selected from the group consisting of Mg, Fe, Ni, Co and Al. Among these, a compound containing Mg, Fe or Al is more preferable. Examples of the M2 source include sulfates, halides (chlorides, fluorides, bromides or iodides), nitrates, phosphates and organic acid salts (such as oxalates or acetates) of the M2 element. The M2 source is preferably that which easily dissolves in the solvent used in the hydrothermal synthesis reaction. Among these, divalent transition metal sulfates are preferable, and magnesium sulfate, iron (II) sulfate or aluminum sulfate as well as hydrates thereof are preferable. Lix₂M2y₂Pz₂O₄ containing these M2 elements has superior cycle characteristics. The cycle characteristics of a positive electrode active material can be improved by the presence of Lix₂M2y₂Pz₂O₄ in the form of a shell layer on the surface of particles of the positive electrode active material.

(Second Raw Material Blending Ratio)

The blending ratio of the second raw material in the second step (blending ratio of the M2 source, excess Li source and excess phosphoric acid source) is such that the added amount of the M2 source is adjusted in accordance with the excess Li source and the excess phosphoric acid source so that a shell portion is obtained of the composition Lix₂M2y₂Pz₂O₄ (where, the letters x₂, y₂ and z₂ representing composition ratios are respectively such that 0<x₁<2, 0<y₁<1.5 and 0.9<z₁<1.1).

For example, a stoichiometrically equivalent amount of M2 source may be added to the excess Li source and the excess phosphoric acid source, and the excess Li source, excess phosphoric acid source and M2 source may each be completely consumed to form the shell portion in the hydrothermal synthesis reaction of the second step. In addition, a stoichiometrically excess amount of the M2 source may be added to the excess Li source and the excess phosphoric acid source, and the excess Li source and the excess phosphoric acid source may be completely consumed to form the shell portion in the hydrothermal synthesis reaction of the second step. Moreover, a stoichiometric deficit of the M2 source may be added to the excess Li source and the excess phosphoric acid source, and the M2 source may be completely consumed to form the shell portion in the hydrothermal synthesis reaction of the second step. In this manner, the amount of the shell portion relative to the core portion can be adjusted according to the excess amounts of the Li source and phosphoric acid source and the added amount of the M2 source.

In addition, a stoichiometric deficit of the M2 source may be added to the excess Li source and the excess phosphoric acid source, and the M2 source may be completely consumed to form the shell portion in the hydrothermal synthesis reaction of the second step, followed by adding a different M2 source and carrying out the hydrothermal synthesis reaction. In this manner, a plurality of shell layers can be sequentially laminated by adding M2 sources over a plurality of times and carrying out the hydrothermal synthesis reaction of the second step over a plurality of times.

(Hydrothermal Synthesis Reaction in Second Step)

In a preferable production method of the present embodiment, hydrothermal synthesis is carried out by reacting the excess Li source, excess phosphoric acid source and M2 source at 100° C. or higher. At this time, the temperature of the reaction liquid between the first and second steps is maintained at 100° C. or higher. The reaction temperature of the hydrothermal synthesis reaction in the second step is 100° C. or higher immediately after the start of the reaction as a result of maintaining the temperature of the reaction liquid between the first and second steps at 100° C. or higher. As a result of making the reaction temperature immediately after the start of the hydrothermal synthesis reaction in the second step to be 100° C. or higher, a shell layer of the composition Lix₂M2y₂Pz₂O₄ is formed on the surface of the core portion without the M2 element diffusing and penetrating into the core portion. Since the M2 element does not diffuse into the core portion, there is no decrease in the composition ratio of the M2 element in the core layer, and a shell layer of a target composition can be obtained. In addition, since the M2 element does not diffuse into the core portion, there is no shortage of the amount of shell layer formed, thereby allowing the formation of a target amount of the shell layer. Furthermore, although the heating temperature can be selected as necessary provided it is 100° C. or higher, it is preferably 160° C. to 280° C. and more preferably 180° C. to 200° C. In addition, although the pressure at this time can also be selected as necessary, it is preferably 0.6 MPa to 6.4 MPa and more preferably 1.0 MPa to 1.6 MPa.

In order to maintain the temperature of the reaction liquid between the first and second steps at 100° C. or higher, in addition to maintaining the temperature of the reaction liquid following completion of the first step at 100° C. or higher in the autoclave, the M2 source is gradually added to the reaction liquid after heating to 100° C. or higher and preferably 150° C. or higher. The M2 source may be added over a plurality of times. A positive electrode active material having a core portion and a shell layer can be obtained by not adding the entire amount of the M2 source all at once. In addition, a temperature drop of the reaction liquid can be prevented by adding the M2 source while heated to 100° C. or higher. The aforementioned temperature control is preferably also carried out in the same manner in the second step in the case of adding the M2 source over a plurality of times.

A conversion reaction to Lix₂M2y₂Pz₂O₄ is initiated and allowed to proceed at 100° C. or higher by gradually adding the M2 source heated to 100° C. or higher to the reaction liquid.

The aforementioned reaction is carried out following the first step in a pressure-resistant vessel in the manner of an autoclave. The inside of the reaction vessel is continued to be replaced with an inert gas or reducing gas.

Although the reducing gas can be selected arbitrarily, examples thereof include nitrogen and argon.

As a result of this conversion reaction, a shell layer composed of Lix₂M2y₂Pz₂O₄ is grown on the surface of the core portion. In this manner, a suspension is obtained that contains the positive electrode active material provided with a core portion and a shell layer according to the present embodiment.

The resulting suspension is allowed to cool to room temperature followed by solid-liquid separation. Since unreacted lithium ions and the like are contained in the separated liquid, materials such as the Li source can be recovered from the separated liquid. There are no particular limitations on the recovery method. For example, lithium phosphate can be precipitated by adding a basic phosphoric acid source to the separated liquid. The aforementioned precipitate can be then be recovered and reused as a phosphoric acid source.

Positive electrode active material separated from the suspension is dried after washing as necessary. Drying conditions are preferably selected such that the metals M1 and M2 are not oxidized. Vacuum drying is preferably used for the aforementioned drying.

In addition, in order to further impart electrical conductivity to the positive electrode active material, the resulting positive electrode active material is mixed with a carbon source, and the aforementioned mixture is then subjected to vacuum drying as necessary. Next, the aforementioned mixture is fired preferably at a temperature of 500° C. to 800° C. in an inert atmosphere or reducing atmosphere. As a result of carrying out this firing, a positive electrode material can be obtained in which a carbon material has adhered to the surface of the shell portion. Firing conditions are preferably selected such that the M1 and M2 elements are not oxidized.

Preferable examples of carbon sources able to be used in the aforementioned firing include sugars such as sucrose or lactose, and water-soluble organic substances such as ascorbic acid, 1,6-hexanediol, polyethylene glycol, polyethylene oxide or carboxymethyl cellulose. In addition, carbon black or filamentous carbon may also be used.

(Positive Electrode Active Material for Lithium Secondary Battery)

A positive electrode active material obtained in this manner is composed of a core portion composed of an olivine-type lithium metal phosphate represented by Lix₁M1y₁Pz₁O₄, and a shell layer composed of an olivine-type lithium metal phosphate represented by Lix₂M2y₂Pz₂O₄. The positive electrode active material may be composed of only one shell layer or two or more shell layers. In addition, a carbon material may be adhered to the surface of the shell layer in order to improve electrical conductivity.

The core portion is composed of an olivine-type lithium metal phosphate represented by Lix₁M1y₁Pz₁O₄. The letters x₁, y₁ and z₁ representing composition ratios are respectively such that 0<x₁<2, 0<y₁<1.5 and 0.9<z₁<1.1). More preferably, x₁, y₁ and z₁ are respectively such that 0.5<x₁<1.5, 0.7<y₁<1.0 and 0.9<z₁<1.1, and most preferably such that 1.0≦x₁≦1.2, y₁=1.0 and z₁=1.0. In addition, although M1 can be selected arbitrarily, it is preferably one type or two or more types of Mg, Ca, Fe, Mn, Ni, Co, Zn, Ge, Cu, Cr, Ti, Sr, Ba, Sc, Y, Al, Ga, In, Si, B or rare earth elements, more preferably one type or two or more types of Fe, Mn, Ni or Co, and most preferably Fe and/or Mn.

In addition, the shell layer is composed of an olivine-type lithium metal phosphate represented by Lix₂M2y₂Pz₂O₄. The letters x₂, y₂ and z₂ representing composition ratios are respectively such that 0<x₂<2, 0<y₂<1.5 and 0.9<z₂<1.1). More preferably, x₁, y₁ and z₁ are respectively such that 0.5<x₂<1.5, 0.7<y₂<1.0 and 0.9<z₂<1.1, and most preferably such that 1.0≦x₂≦1.2, y₂=1.0 and z₂=1.0. In addition, although M1 can be selected arbitrarily, it is preferably one type or two or more types of Mg, Fe, Ni, Co or Al, and more preferably Mg, Fe or Al. Covering the core portion with the shell layer makes it possible to improve cycle characteristics of the positive electrode active material.

In addition, the weight ratio of the shell layer in the positive electrode active material is preferably within the range of 1.5% by weight to 71% by weight, more preferably within the range of 8% by weight to 43% by weight, and even more preferably within the range of 14% by weight to 25% by weight. Cycle characteristics of the positive electrode active material can be improved considerably by making the weight ratio of the shell layer to be 1.5% by weight or more. In addition, charge-discharge capacity of the positive electrode active material can be enhanced by making the weight ratio of the shell layer to be 25% by weight or less. In addition, the weight ratio of the core portion in the positive electrode active material is the remainder of the positive electrode active material not composed by the shell layer.

In addition, the mean particle diameter D₅₀, which is the particle diameter at 50% in the cumulative distribution of particle diameter based on the volume of the positive electrode active material, is preferably 0.02 μm to 0.2 μm and more preferably 0.05 μm to 0.1 μm. If the mean particle diameter D₅₀ is within the aforementioned ranges, both cycle characteristics and charge-discharge capacity can be improved.

In addition, the thickness of the shell layer is preferably 50% or less of the radius of the particle diameter of the core layer. Moreover, the particle diameter of the core portion is preferably within the range of 65% or more of the particle diameter of the positive electrode active material. Both cycle characteristics and charge-discharge capacity can be improved if the thickness of the shell layer and the particle diameter of the core portion are within the aforementioned ranges.

In addition, the rate of increase of specific surface area when put into the form of a core-shell structure is preferably within 10% of the specific surface area of the core portion. As a result, both cycle characteristics and charge-discharge capacity can be improved. Although the lower limit of the aforementioned rate of increase can be selected arbitrarily, it is typically 1% or more. Furthermore, the rate of increase of specific surface area refers to the difference between the specific surface area of the shell portion and the specific surface area of the core portion being within 10%.

(Lithium Secondary Battery)

A preferable lithium secondary battery of the present embodiment is composed by being provided with a positive electrode, a negative electrode and a nonaqueous electrolyte. In this lithium secondary battery, an olivine-type lithium metal phosphate having a core-shell structure produced according to the previously described method is used for the positive electrode active material contained in the positive electrode. As a result of being provided with this type of positive electrode active material, the energy density of the lithium secondary battery can be improved and cycle characteristics can be further enhanced. The following sequentially provides explanations of the positive electrode, negative electrode and nonaqueous electrolyte that compose the lithium secondary battery.

(Positive Electrode)

In the lithium secondary battery in a preferred embodiment of the present invention, a sheet-like electrode composed of a positive electrode mixture, obtained by containing a positive electrode active material, a conductive assistant and a binder, and a positive electrode current collector conjugated to the positive electrode mixture, can be used for the positive electrode. In addition, a pellet-like or sheet-like positive electrode, obtained by molding the aforementioned positive electrode mixture into the shape of a disc, can also be used as a positive electrode.

Although lithium metal phosphate produced according to the aforementioned method is used for the positive electrode active material, conventionally known positive electrode active materials may also be mixed with this lithium metal phosphate.

Examples of binders include polyethylene, polypropylene, ethylene-propylene copolymer, ethylene-propylene terpolymer, butadiene rubber, styrene-butadiene rubber, butyl rubber, polytetrafluoroethylene, poly(meth)acrylate, polyvinylidene fluoride, polyethylene oxide, polypropylene oxide, polyepichlorohydrin, polyphosphazene and polyacrylonitrile.

Moreover, examples of conductive assistants include conductive metal powders such as silver powder, conductive carbon powders such as furnace black, Ketjen black or acetylene black, carbon nanotubes, carbon nanofibers and vapor grown carbon fibers. Vapor grown carbon fibers are preferably used for the conductive assistant. The fiber diameter of the vapor grown carbon fibers is preferably 5 nm to 0.2 μm. The ratio of fiber length to fiber diameter is preferably 5 to 1000. The content of vapor grown carbon fibers based on the dry weight of the positive electrode mixture is preferably 0.1% by weight to 10% by weight.

Moreover, examples of positive electrode current collectors include conductive metal foil, conductive metal mesh and perforated conductive metal. Aluminum or aluminum alloy is preferable for the conductive metal. Carbon is more preferably coated onto the surface of the positive electrode current collector since it lowers contact resistance with the positive electrode mixture.

(Negative Electrode)

A sheet-like electrode composed of a negative electrode mixture, obtained by containing a negative electrode active material, a binder and a conductive assistant added as necessary, and a negative electrode current collector conjugated to the negative electrode mixture, can be used for the negative electrode. In addition, a pellet-like or sheet-like negative electrode, obtained by molding the aforementioned negative electrode mixture into the shape of a disc, can also be used for the negative electrode.

A conventionally known negative electrode active material can be used for the negative electrode active material. Examples of materials that can be used include carbon materials such as synthetic graphite or natural graphite, and metallic or semi-metallic materials such as Sn or Si.

A binder similar to that used in the positive electrode can be used for the binder.

Moreover, a conductive assistant may or may not be added as necessary. Examples of conductive assistants that can be used include conductive carbon powders such as furnace black, Ketjen black or acetylene black, carbon nanotubes, carbon nanofibers and vapor grown carbon fibers. Vapor grown carbon fibers are used particularly preferably for the conductive assistant. The fiber diameter of the vapor grown carbon fibers is preferably 5 nm to 0.2 μm. The ratio of fiber length to fiber diameter is preferably 5 to 1000. The content of vapor grown carbon fibers based on the dry weight of the negative electrode mixture is preferably 0.1% by weight to 10% by weight.

Moreover, examples of materials used for the negative electrode current collector include conductive metal foil, conductive metal mesh and perforated conductive metal. Copper or copper alloy is preferable for the conductive metal.

(Nonaqueous Electrolyte)

Next, an example of the nonaqueous electrolyte is a nonaqueous electrolyte obtained by dissolving a lithium salt in an aprotic solvent.

Although the aprotic solvent can be selected arbitrarily, at least one type, or a mixed solvent of two or more types, selected from the group consisting of ethylene carbonate, diethyl carbonate, dimethyl carbonate, methyl ethyl carbonate, propylene carbonate, butylene carbonate, γ-butyrolactone and vinylene carbonate is preferable.

In addition, examples of the lithium salt include LiClO₄, LiPF₆, LiAsF₆, LiBF₄, LiSO₃CF₃, CH₃SO₃Li and CF₃SO₃Li.

In addition, a so-called solid electrolyte or gel electrolyte can also be used for the nonaqueous electrolyte. Examples of solid electrolytes or gel electrolytes include polymer electrolytes such as sulfonated styrene-olefin copolymers, polymer electrolytes using polyethylene oxide and MgClO₄, and polymer electrolytes having a trimethylene oxide structure. Although the nonaqueous electrolyte used in a polymer electrolyte can be selected arbitrarily, at least one type selected from the group consisting of ethylene carbonate, diethyl carbonate, dimethyl carbonate, methyl ethyl carbonate, propylene carbonate, butylene carbonate, γ-butyrolactone and vinylene carbonate is preferable.

Moreover, the lithium secondary battery in a preferred embodiment of the present invention is not limited to that provided with only a positive electrode, negative electrode and nonaqueous electrolyte, but rather may also be provided with other members and the like as necessary, and may be provided with, for example, a separator that separates the positive electrode and negative electrode. A separator is required in the case the nonaqueous electrolyte is not a polymer electrolyte. Examples of separators include non-woven fabrics, woven fabrics, microporous films and combinations thereof, and more specifically, a porous polypropylene film or porous polyethylene film and the like can be used appropriately.

The lithium secondary battery of the present embodiment can be used in various fields.

Examples thereof include electrical and electronic devices such as personal computers, tablet computers, notebook computers, cellular telephones, wireless transceivers, electronic organizers, electronic dictionaries, personal digital assistants (PDA), electronic meters, electronic keys, electronic tags, power storage devices, power tools, toys, digital cameras, digital video recorders, audio-visual equipment or vacuum cleaners, transportation means such as electric vehicles, hybrid vehicles, electric motorcycles, hybrid motorcycles, motorized bicycles, power-assisted bicycles, trains, aircraft or marine vessels, and electrical power generation systems such as solar power generation systems, wind power generation systems, tidal power generation systems, geothermal power generation systems, temperature difference power generation systems or vibration power generation systems.

According to a preferable positive electrode active material of a lithium secondary battery of the present embodiment, since the positive electrode active material is composed of a core portion composed of an olivine-type lithium metal phosphate represented by Lix₁M1y₁Pz₁O₄ and one or more shell layers composed of an olivine-type lithium metal phosphate represented by Lix₂M2y₂Pz₂O₄, charge-discharge capacity and cycle characteristics of the positive electrode active material can be improved.

In addition, as a result of further adhering a carbon material to the surface of the shell layer, the resistivity of the positive electrode active material can be reduced and energy density of the positive electrode active material can be enhanced.

Next, according to a preferable method for producing a positive electrode active material of a lithium secondary battery of the present embodiment, an M1 source, excess Li source with respect to the M1 source and excess phosphoric acid source with respect to the M1 source are used as a first raw material, and a hydrothermal synthesis reaction is carried out on that first raw material to form a reaction liquid containing a core portion composed of an olivine-type lithium metal phosphate represented by Lix₁M1y₁Pz₁O₄. By further mixing an M2 source into this reaction liquid, using an excess Li source, an excess phosphoric acid source and the M2 source contained in the reaction liquid as a second raw material and carrying out a hydrothermal synthesis reaction on the second raw material to form a shell portion composed of an olivine-type lithium metal phosphate represented by Lix₂M2y₂Pz₂O₄ on the surface of the core portion, adhesion between the core portion and the shell layer improves. As a result, the migration of lithium ions and electrons at the boundary between the core portion and the shell layer is facilitated, internal resistance is inhibited, and a positive electrode active material can be produced that has high charge-discharge capacity and superior cycle characteristics.

In addition, together with carrying out each hydrothermal synthesis reaction in the first and second steps at 100° C. or higher, if the temperature of the reaction liquid between the first and second steps is maintained at 100° C. or higher, a shell layer having the composition of Lix₂M2y₂Pz₂O₄ can be formed on the surface of the core portion. In addition, since the M2 element does not diffuse into the core portion, a shell portion of a target composition can be obtained without any decrease in the composition ratio of the M2 element in the shell portion. In addition, since the M2 element does not diffuse into the core portion, there is no shortage of the amount of shell layer formed, thereby allowing the formation of a target amount of the shell layer.

Furthermore, in the present invention, the term “plurality” refers to an arbitrary number of at least two or more.

### EXAMPLES

### Example 1

### 1. Hydrothermal Synthesis Step

Dissolved carbon dioxide gas and oxygen were expelled from distilled water by bubbling with nitrogen gas for 15 hours in a safety cabinet filled with argon gas. 44.1 g of an Li source in the form of LiOH.H₂O (Kanto Chemical, Cica reagent) and 40.4 g of a P source in the form of H₃PO₄ (Kanto Chemical, special grade, concentration: 85.0%) were mixed with 100 mL of this distilled water to obtain a Liquid A. The excess amount of Li with respect to an M1 source was 11 g, and the excess amount of the P source was 10 g.

Next, 63.3 g of an M1 source in the form of MnSO₄.5H₂O (Kanto Chemical, special grade) and 0.462 g of L(+)-ascorbic acid (Kanto Chemical, special grade) were dissolved in 300 mL of distilled water subjected to bubbling treatment in the same manner as described above to obtain a Liquid B.

Moreover, 24.3 g of an M2 source in the form of FeSO₄.7H₂O (Wako Pure Chemical Industries, special grade) and 0.154 g of L(+)-ascorbic acid (Kanto Chemical, special grade) were dissolved in 100 mL of distilled water subjected to bubbling treatment in the same manner as described above to obtain a liquid C.

Next, Liquid A and Liquid B were placed in an SUS316 reaction vessel of a TEM-V100N HyperGlastar Simple Autoclave (Taiatsu Techno) and the cover of the reaction vessel was closed. An NP-S-461 Single Plunger Pump (Nihon Seimitsu Kagaku) was connected to the autoclave with a pipe, and a pipe heater was attached to the pipe to enable the pipe to be heated.

Next, the reaction vessel was placed in the autoclave, the gas intake nozzle and gas evacuation nozzle of the autoclave were opened, and nitrogen gas was introduced into the autoclave for 5 minutes from the gas intake nozzle at a flow rate of 1 L/min. After 5 minutes, the gas evacuation nozzle was closed followed by opening the gas intake nozzle to fill the reaction vessel with nitrogen gas. Next, stirring of the first raw material in the reaction vessel was begun at a stirrer stirring rate of 300 rpm. A hydrothermal synthesis reaction was allowed to proceed by raising the temperature to 200° C. in a heating time of 1 hour and holding at 200° C. for 6 hours, resulting in the synthesis of a core portion composed of a lithium metal phosphate having the composition LiMnPO₄. The excess amount of the Li source was 11 g and the excess amount of the P source was 10 g.

Next, Liquid C heated to 200° C. was introduced into the reaction vessel within the autoclave at a feed rate of 17 mL/hr by means of the pipe and single plunger pump preliminarily connected to the autoclave. The pipe was continuously heated with a pipe heater, and the temperature of the Liquid C was controlled so as to not fall below 150° C. Following completion of introduction of Liquid C, the temperature was held at 200° C. for 1 hour while continuing to stir. After holding at that temperature for 1 hour, heating was discontinued and the suspension was allowed to cool to room temperature while continuing to stir. A shell layer having the composition LiFePO₄ was formed in this manner.

Next, after cooling to room temperature, the suspension present in the reaction vessel was removed from the autoclave and subjected to solid-liquid separation with a centrifuge. A procedure consisting of discarding the resulting supernatant, adding additional distilled water, stirring the solid to redisperse, re-centrifuging the redispersed liquid and discarding the supernatant was repeated until the electrical conductivity of the supernatant became 1×10⁻⁴ S/cm or less. Subsequently, drying was carried out in a vacuum dryer controlled to 90° C. Lithium metal phosphate having a core-shell structure was obtained in this manner.

### 2. Carbon Film Formation Step

5.0 g of the resulting dried lithium metal phosphate were weighed out, and after adding 0.5 g of sucrose and further adding 2.5 ml of distilled water and mixing, the mixture was dried in a vacuum dryer controlled to 90° C. The dried product was placed in an aluminum boat and placed in a tube furnace equipped with a quartz tube having a diameter of 80 mm for the core. The gaseous sucrose degradation product was discharged outside the system by raising the temperature at the rate of 100° C./hr while introducing nitrogen at a flow rate of 1 L/min and holding at 400° C. for 1 hour. Subsequently, the temperature was raised to 700° C. at the rate of 100° C./hr and held at that temperature for 4 hours while introducing nitrogen. After the 4 hours had elapsed, the fired product was cooled to 100° C. or lower while introducing nitrogen followed by removing from the tube furnace to obtain a positive electrode active material.

### 3. Battery Evaluation

1.5 g of the positive electrode active material, 0.43 g of a conductive assistant in the form of acetylene black (HS-100, Denki Kagaku Kogyo) and 0.21 g of a binder in the form of polyvinylidene fluoride (KF Polymer W #1300, Kureha) were respectively weighed. After mixing well, 3.0 g of N-methyl-2-pyrrolidone (Kishida Chemical) were gradually added thereto to obtain a coating liquid. This coating liquid was coated onto aluminum foil having a thickness of 20 μm with a doctor blade coater following adjustment of the gap thereof. After drying the N-methyl-2-pyrrolidone from the resulting coated film, a portion of the film was cut out in the shape of a circle having a diameter of 15 mm. Subsequently, when the thickness of the cut out coating film was measured after pressing for 20 seconds at 3 MPa, the average film thickness was determined to be 43 μm. In addition, the weight of the coating film was 8.3 mg. A positive electrode was produced in this manner.

The resulting positive electrode was introduced into a safety cabinet filled with argon in which the dew point was controlled to −75° C. or lower. The positive electrode was placed on a cover for a type 2320 coin-type battery (Housen) followed by the addition of electrolyte (1 M LiPF₆, EC:MEC=40:60). Moreover, a separator cut out to a diameter of 20 mm (Celgard 2400) and lithium metal foil cut out to a diameter of 17.5 mm were sequentially layered thereon. A cap equipped with a gasket was then placed thereon and sealed to produce a coin-type battery having a diameter of 23 mm and thickness of 2 mm.

### Example 2

A coin-type battery was produced under the same conditions as Example 1 with the exception of changing the weight of the M2 source to 14.6 g of FeSO₄.7H₂O (Wako Pure Chemical Industries, special grade) and changing the weight of the M1 source to 71.7 g of MnSO₄.5H₂O (Kanto Chemical, special grade). The excess amount of the Li source with respect to the M1 source was 6.6 g, and the excess amount of the P source was 6.0 g.

### Example 3

A coin-type battery was produced under the same conditions as Example 1 with the exception of changing the weight of the M2 source to 9.7 g of FeSO₄.7H₂O (Wako Pure Chemical Industries, special grade) and changing the weight of the M1 source to 75.9 g of MnSO₄.5H₂O (Kanto Chemical, special grade). The excess amount of the Li source with respect to the M1 source was 4.4 g, and the excess amount of the P source was 4.0 g.

### Example 4

A coin-type battery was produced under the same conditions as Example 1 with the exception of using 24.6 g of CoSO₄.7H₂O instead of FeSO₄.7H₂O (Wako Pure Chemical Industries, special grade) for the M2 source. The excess amount of the Li source with respect to the M1 source was 11 g, and the excess amount of the P source was 10 g.

### Example 5

A coin-type battery was produced under the same conditions as Example 1 with the exception of fabricating a first layer under the same shell layer fabrication conditions as Example 1 using 9.8 g of CoSO₄.7H₂O (Kanto Chemical, Cica reagent) for the M2 source, and fabricating a second layer of the shell layer using 14.6 g of FeSO₄.7H₂O for the M2 source.

### Example 6

A coin-type battery was produced under the same conditions as Example 1 with the exception of using 18.2 g of FeSO₄.7H₂O (Wako Pure Chemical Industries, special grade) and 47.5 g of MnSO₄.5H₂O (Kanto Chemical, special grade) for the M1 source of the core portion. The excess amount of the Li source with respect to the M1 source was 11 g, and the excess amount of the P source was 10 g.

### Comparative Example 1

Liquid A was prepared in the same manner as Example 1.

In addition, 97.311 g of an M2 source in the form of FeSO₄.7H₂O (Wako Pure Chemical Industries, special grade) and 0.616 g of L(+)-ascorbic acid (Kanto Chemical, special grade) were dissolved in 400 mL of distilled water subjected to bubbling treatment in the same manner as Example 1 to obtain a Liquid D.

Next, Liquid A was placed in an SUS316 reaction vessel of a TEM-V100N HyperGlastar Simple Autoclave (Taiatsu Techno) and the cover of the reaction vessel was closed. An NP-S-461 Single Plunger Pump (Nihon Seimitsu Kagaku) was connected to the autoclave with a pipe, and a pipe heater was attached to the pipe to enable the pipe to be heated.

Next, the reaction vessel was placed in the autoclave, the gas intake nozzle and gas evacuation nozzle of the autoclave were opened, and nitrogen gas was introduced into the autoclave for 5 minutes from the gas intake nozzle at a flow rate of 1 L/min. After 5 minutes, the gas evacuation nozzle was closed followed by opening the gas intake nozzle to fill the reaction vessel with nitrogen gas. Next, stirring of the raw material in the reaction vessel was begun at a stirrer stirring rate of 300 rpm. The temperature was then raised to 200° C. in a heating time of 1 hour.

Next, Liquid D heated to 200° C. was introduced into the reaction vessel within the autoclave at a feed rate of 17 mL/hr by means of the pipe and single plunger pump preliminarily connected to the autoclave. The pipe was continuously heated with a pipe heater, and the temperature of the Liquid D was controlled so as to not fall below 150° C. Following completion of introduction of Liquid D, the temperature was held at 200° C. for 7 hours while continuing to stir. After holding at that temperature for 7 hours, heating was discontinued and the suspension was allowed to cool to room temperature while continuing to stir. A shell layer was formed in this manner.

Lithium metal phosphate having the composition LiFePO₄ was synthesized in this manner.

A carbon film was formed on the resulting lithium metal phosphate in the same manner as Example 1 to obtain a positive electrode active material. A coin-type battery was produced in the same manner as Example 1 using the resulting positive electrode active material, and a charge-discharge cycle test was carried out on the resulting coin-type battery.

### Comparative Example 2

A coin-type battery was produced under the same conditions as Comparative Example 1 with the exception of using 84.4 g of MnSO₄.5H₂O (Kanto Chemical, special grade) instead of FeSO₄.7H₂O (Wako Pure Chemical Industries, special grade), and a charge-discharge cycle test was carried out on the resulting coin-type battery. The composition of the resulting lithium metal phosphate was LiMnPO₄.

### Comparative Example 3

63.3 g of MnSO₄.5H₂O (Kanto Chemical, special grade), 24.3 g of FeSO₄.7H₂O (Wako Pure Chemical Industries, special grade) and 0.616 g of L(+)-ascorbic acid (Kanto Chemical, special grade) were dissolved in 400 mL of distilled water subjected to bubbling treatment in the same manner as Example 1, and this was used as a Liquid E instead of Liquid D. A coin-type battery was then produced under the same conditions as Comparative Example 1 with the exception of the above, and a charge-discharge cycle test was carried out on the resulting coin-type battery. The composition of the resulting lithium metal phosphate was LiFe_{0.25}Mn_{0.75}PO₄.

### Comparative Example 4

An experiment was conducted consisting of lowering the temperature following the preparation of core particles and forming a shell portion therefrom with reference to Japanese Unexamined Patent Application, First Publication No. 2007-213866.

First, Liquid A, Liquid B and Liquid C were prepared in the same manner as Example 1.

Next, Liquid A and Liquid B were placed in an SUS316 reaction vessel of a TEM-V100N HyperGlastar Simple Autoclave (Taiatsu Techno) and the cover of the reaction vessel was closed. An NP-S-461 Single Plunger Pump (Nihon Seimitsu Kagaku) was connected to the autoclave with a pipe, and a pipe heater was attached to the pipe to enable the pipe to be heated.

Next, the reaction vessel was placed in the autoclave, the gas intake nozzle and gas evacuation nozzle of the autoclave were opened, and nitrogen gas was introduced into the autoclave for 5 minutes from the gas intake nozzle at a flow rate of 1 L/min. After 5 minutes, the gas evacuation nozzle was closed followed by opening the gas intake nozzle to fill the reaction vessel with nitrogen gas. Next, stirring of the first raw material in the reaction vessel was begun at a stirrer stirring rate of 300 rpm. A hydrothermal synthesis reaction was allowed to proceed by raising the temperature to 200° C. in a heating time of 1 hour and holding at 200° C. for 6 hours, resulting in the synthesis of a core portion composed of lithium metal phosphate having the composition LiMnPO₄. Subsequently, the core portion was cooled until the temperature in the reaction vessel reached room temperature.

Subsequently, Liquid C was placed in an NP-S-461 Single Plunger Pump (Nihon Seimitsu Kagaku) connected to the autoclave through a pipe heater, and Liquid C was introduced into the autoclave at a feed rate of 17 mL/min. Following completion of introduction of Liquid C, the temperature was raised to 200° C. in a heating time of 1 hour while continuing to stir, and held at 200° C. for 1 hour. After holding at that temperature for 1 hour, heating was discontinued and the suspension was allowed to cool to room temperature while continuing to stir. A shell portion composed of lithium metal phosphate having the composition LiFePO₄ was formed on the surface of a core portion composed of LiMnPO₄ in this manner.

Subsequently, the temperature inside the reaction vessel was allowed to cool to room temperature, a positive electrode active material was obtained by forming a carbon film in the same manner as Example 1, a coin-type battery was produced under the same conditions as Example 1, and a charge-discharge cycle test was carried out on the resulting battery.

### Comparative Example 5

The LiFePO₄ obtained in Comparative Example 1 and the LiMnPO₄ obtained in Comparative Example 2 were mixed at a weight ratio of 75:25, and a shell layer was coated onto core particles by dry coating using the same technique as that described in Example 1 of Japanese Unexamined Patent Application Publication (Translation of PCT Application) No. 2011-502332. A positive electrode active material composed of lithium metal phosphate having a core-shell structure having a shell layer composed of LiMnPO₄ was synthesized, and a carbon film was formed on the surface of the shell layer in the same manner as Example 1. A coin-type battery was produced under the same conditions as Example 1, and a charge-discharge cycle test was carried out using this coin-type battery.

### Comparative Example 6

The LiFePO₄ obtained in Comparative Example 1 and the LiMnPO₄ obtained in Comparative Example 2 were mixed at a weight ratio of 75:25 to obtain a positive electrode active material composed of lithium metal phosphate, a carbon film was formed on the surface of the lithium metal phosphate in the same manner as Example 1, a coin-type battery was produced under the same conditions as Example 1, and a charge-discharge cycle test was carried out on the resulting coin-type battery.

(Material Evaluation)

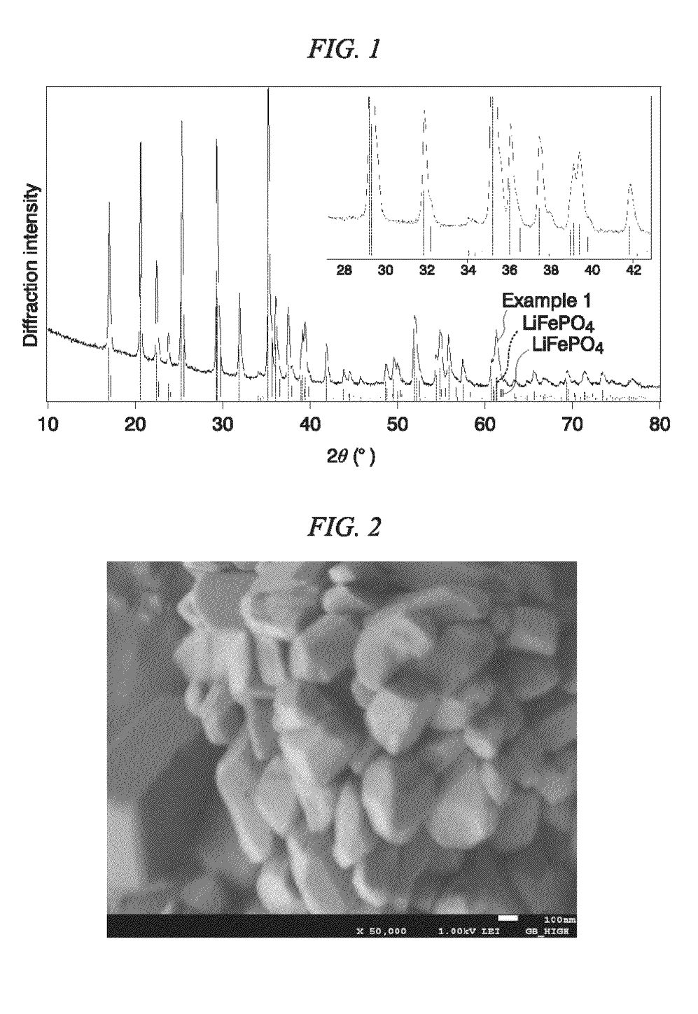

The positive electrode active material obtained in Example 1 was measured by X-ray diffraction using CuKα radiation (X'Pert Powder, PANalytical). As a result, the positive electrode active material of Example 1 was confirmed to have two phases consisting of LiFePO₄ and LiMnPO₄ as shown in FIG. 1. This is thought to be the result of LiMnPO₄ being formed first followed by the formation of LiFePO₄ thereon. The diffraction lines (2θ) of LiFePO₄ and LiMnPO₄ are shown at the bottom of FIG. 1. In addition, the respective phases were also confirmed for Examples 2 to 6.

In addition, the positive electrode active material of Example 1 was confirmed by RIR to have a weight ratio of LiFePO₄ to LiMnPO₄ of 25:75 (w/w) using integrated X-ray powder diffraction analysis software in the form of PDXL (Rigaku).

The positive electrode active materials of Comparative Examples 1, 2 and 3 were similarly confirmed to have formed LiFePO₄, LiMnPO₄ and LiFe_{0.25}Mn_{0.75}PO4, respectively (compositions determined according to Vegard's law).

On the other hand, a definitive phase indicating LiFePO₄ was unable to be confirmed in the case of Comparative Example 4. This is thought to be the result of having gone through a heating process during formation of the shell layer, thereby causing the LiMnPO₄ and Fe to react gradually and resulting in the loss of the LiFePO₄ phase.

In addition, each of the phases of LiFePO₄ and LiMnPO₄ were confirmed in Comparative Examples 5 and 6.

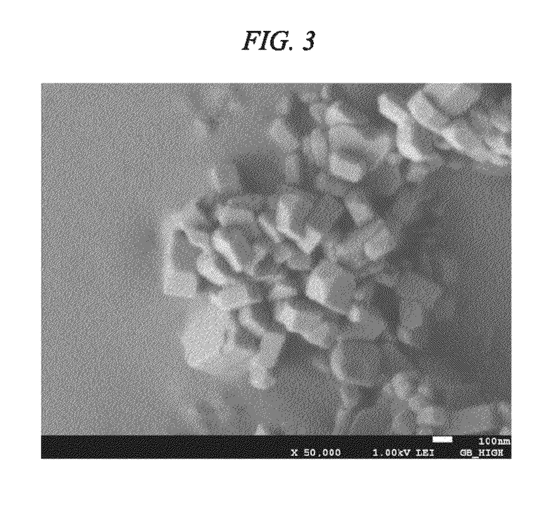

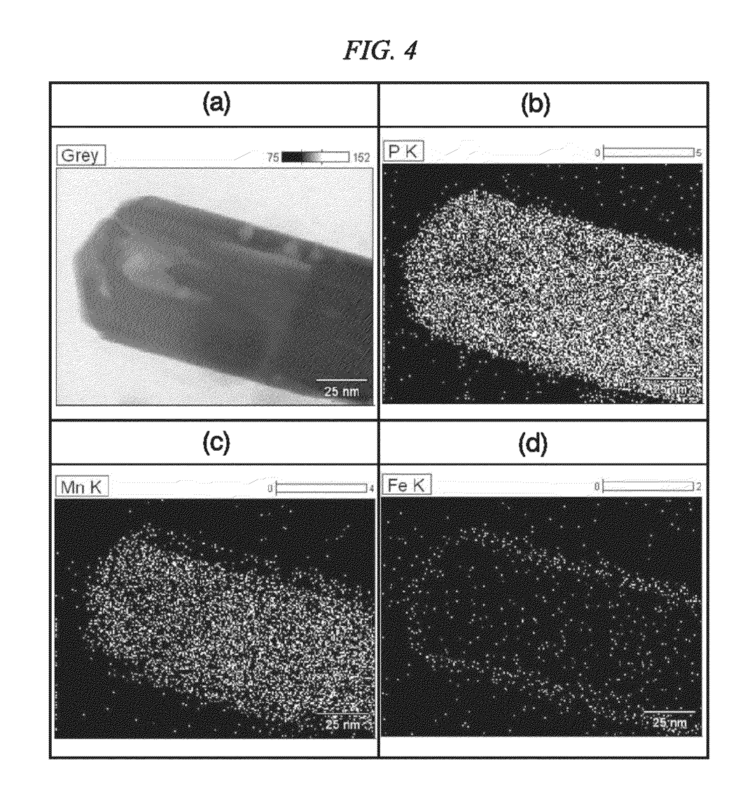

Next, scanning electron micrographs (SEM) of the positive electrode active materials obtained in Example 1 and Comparative Example 3 are respectively shown in FIGS. 2 and 3. According to FIGS. 2 and 3, the active material of Example 1 can be understood to have a larger particle diameter in comparison with that of Comparative Example 3 and have irregularities in the surface thereof. This is thought to be the result of a shell layer composed of LiFePO₄ having been formed on a core portion composed of LiMnPO₄. In addition, FIG. 4 depicts an image of the positive electrode active material of Example 1 generated by STEM-EDS mapping. FIG. 4 shows elemental mappings of P (FIG. 4(a)), Mn (FIG. 4(b)) and Fe (FIG. 4(c)) along with the corresponding electron micrograph (FIG. 4(d)). As shown in FIG. 4, since Fe is segregated on the particle surfaces, an LiFePO₄ layer can be understood to be present on the surfaces of the particles.

On the basis of these results, lithium metal phosphate having a core-shell structure in which the core portion is composed of LiMnPO₄ and the shell portion is composed of LiFePO₄ can be said to have been obtained in Example 1.

In addition, the results of vacuum-drying each sample for 1 hour at 120° C. followed by measuring the BET specific surface area thereof using a Gemini 2475 (Micromeritics) are summarized in Table 1. According to the results obtained for Examples 1 to 5 and Comparative Example 2 and the results obtained for Example 6 and Comparative Example 3, in the case of using this method, the rate of increase of surface area when a core-shell structure has been formed from a core portion is held to within 10% even if the weight ratio between the core portion and shell layer is changed. On the other hand, according to Comparative Examples 1 and 5, in the case of mixing particles (with the shell having a smaller particle diameter), the increase in specific surface area cannot be held to 10% even if the blending ratio is the same as that of Example 1.

Reference values were used for the specific surface areas of the core portion of the core-shell structures in Comparative Examples 1 to 3.

(Battery Evaluation)

The coin-type batteries of Example 1 and Comparative Examples 1 to 6 were constant-current charged to 4.5 V at a temperature of 25° C. and current value of 0.1 C followed by constant-voltage charging at 4.5 V until the current value reached 0.01 C. Subsequently, the batteries were repeatedly subjected to 15 cycles of constant-voltage discharge to 2.5 V. The discharge capacities and discharge capacity retention ratios are shown in the following Table 1. Discharge capacity is the discharge capacity per weight of the positive electrode active material. In addition, discharge capacity retention ratio is the percentage of the discharge capacity in the 15th cycle versus the discharge capacity in the 1st cycle.

According to Table 1, Example 1 was confirmed to demonstrate cycle characteristics superior to those of Comparative Example 2 consisting of a single phase of LiMnPO₄ and Comparative Example 3 having the composition LiFe_{0.25}Mn_{0.75}PO₄, and was confirmed to demonstrate initial cycle characteristics similar to Comparative Example 1 consisting of a single phase of LiFePO₄.

This is thought to be the result of the shell portion in Example 1 consisting of LiFePO₄ having comparatively favorable cycle characteristics.

On the other hand, although Comparative Example 4 demonstrated favorable cycle characteristics in comparison with Comparative Example 2, they were inferior to the cycle characteristics of Example 1. This is thought to be the result of Fe having diffused into the core portion resulting in the formation of a solid solution by the Mn and Fe, while also resulting in formation of the same phase as Comparative Example 3.

Although Comparative Example 5 also demonstrated favorable cycle characteristics in comparison with Comparative Example 2, there was no difference in cycle characteristics when compared with Comparative Example 6. In this manner, although the cycle characteristics of Comparative Example 5, in which the shell layer was formed by dry coating, and the cycle characteristics of Comparative Example 6, which simply consists of a mixture of LiFePO₄ and LiMnPO₄, were roughly the same, the cycle characteristics of Example 1 produced according to the production method of the present invention were higher than those of Comparative Examples 5 and 6. Thus, it can be understood that the cycle characteristics of a positive electrode active material having a core-shell structure can be greatly improved by the production method of the present invention.

In addition, although Examples 2 and 3, having a higher ratio of the core section than in Example 1, tended to have a lower discharge capacity retention ratio, they still demonstrated a value of 95 mAh/g or higher, which was better than the ratios of Comparative Examples 5 and 6. The reason for the decrease in discharge capacity retention ratio is thought to be the result of reduced thickness of the shell layer and the shell layer not being present over the entire surface of the core portion.

In addition, favorable characteristics were determined to be demonstrated even if the shell portion was composed of LiCoPO₄ as indicated in Example 4.

In addition, favorable characteristics were also determined to be demonstrated even in the case of two or more shell layers as indicated in Example 5.

Moreover, favorable characteristics were determined to be demonstrated even in the case of using two or more types of metal species in the core section in the manner of LiFe_{0.25}Mn_{0.75}PO₄ as indicated in Example 6.

TABLE 1

| | Active Material Composition | | | | | | |
|---|---|---|---|---|---|---|---|
| | Core portion | | | | | | |
| | (values in | | | | | | Rate of increase |
| | parentheses | | Ratio of core | | Discharge | BET specific | of specific |
| | indicate specific | | portion (weight | Discharge | capacity retention | surface area | surface area vs. |
| | surface area) | Shell layer | ratio) | capacity (mAh/g) | ratio (%) | (m2/g) | core portion (%) |
| Ex. 1 | LiMnPO₄ | LiFePO₄ | 0.75 | 108.3 | 98.9 | 7.1 | 2.9 |
| | (6.9 m²/g) | | | | | | |
| Ex. 2 | LiMnPO₄ | LiFePO₄ | 0.85 | 101.9 | 98.3 | 7.2 | 4.3 |
| | (6.9 m²/g) | | | | | | |
| Ex. 3 | LiMnPO₄ | LiFePO₄ | 0.9 | 95.5 | 96.4 | 7.2 | 4.3 |
| | (6.9 m²/g) | | | | | | |
| Ex. 4 | LiMnPO₄ | LiFePO₄ | 0.75 | 98.6 | 82.1 | 7.2 | 4.3 |
| | (6.9 m²/g) | | | | | | |
| Ex. 5 | LiMnPO₄ | LiCoPO₄ | 0.75 | 104.9 | 97.9 | 7.4 | 7.2 |
| | (6.9 m²/g) | LiFePO₄ | | | | | |
| Ex. 6 | LiFe_{0.25}Mn_{0.75}PO₄ | LiFePO₄ | 0.75 | 145.9 | 98.7 | 6.1 | 5.2 |
| | (5.8 m²/g) | | | | | | |
| Comp. Ex. 1 | LiFePO₄ | — | 1 | 150.2 | 99.1 | 3.1 | — |
| Comp. Ex. 2 | LiMnPO₄ | — | 1 | 41.7 | 61.3 | 6.9 | — |
| Comp. Ex. 3 | LiFe_{0.25}Mn_{0.75}PO₄ | — | 1 | 139.5 | 92.3 | 5.8 | — |
| Comp. Ex. 4 | LiFexMnyPO4 | | — | 135.3 | 93.6 | 7 | 1.4 |
| | (composition gradient moving | | | | | | |
| | from center to outside) | | | | | | |
| | (6.9 m²/g) | | | | | | |
| Comp. Ex. 5 | LiFePO₄ | LiMnPO₄ | 0.75 | 79.1 | 80.1 | 4.8 | 54.8 |
| | (3.1 m²/g) | | | | | | |
| Comp. Ex. 6 | LiFePO₄ | — | — | 80.9 | 79.2 | 4.1 | — |
| | LiMnPO₄ | | | | | | |

### INDUSTRIAL APPLICABILITY

According to the positive electrode active material for a lithium secondary battery and the production method thereof of the present application, a positive electrode active material for a lithium secondary battery can be provided that demonstrates superior adhesion between core particles and a shell layer.

1. A method for producing a positive electrode active material for a secondary lithium battery having a core portion and a shell layer, comprising:
a first step for obtaining a reaction liquid containing a core portion composed of an olivine-type lithium metal phosphate represented by Lix₁M1y₁Pz₁O₄ (where, M1 represents one type or two or more types of elements selected from the group consisting of Mg, Ca, Fe, Mn, Ni, Co, Zn, Ge, Cu, Cr, Ti, Sr, Ba, Sc, Y, Al, Ga, In, Si, B and rare earth elements, and the letters x₁, y₁ and z₁ representing composition ratios are respectively such that 0<x₁<2, 0<y₁<1.5 and 0.9<z₁<1.1), an excess Li source and an excess phosphoric acid source by using an M1 source, an excess amount of the Li source with respect to the M1 source and an excess amount of the phosphoric acid source with respect to the M1 source for a first raw material, and carrying out a hydrothermal synthesis reaction using the first raw material; and
a second step for carrying out at least once a step for forming a shell layer composed of an olivine-type lithium metal phosphate represented by Lix₂M2y₂Pz₂O₄ (where, M2 represents one type or two or more types of elements differing from M1 selected from the group consisting of Mg, Fe, Ni, Co and Al, and the letters x₂, y₂ and z₂ representing composition ratios are respectively such that 0<x₂<2, 0<y₂<1.5 and 0.9<z₂<1.1) on the core portion by adding an M2 source to the reaction liquid, using the excess Li source, excess phosphoric acid source and M2 source as a second raw material, and carrying out a hydrothermal synthesis reaction using the second raw material.

2. The method for producing a positive electrode active material for a lithium secondary battery according to claim 1, wherein the hydrothermal synthesis reaction in the first step and in the second step is respectively carried out at 100° C. or higher, and the temperature of the reaction liquid between the first step and the second step is maintained at 100° C. or higher.

3. The method for producing a positive electrode active material for a lithium secondary battery according to claim 1, wherein the M1 source is one type or two or more types selected from the group consisting of a sulfate, halide salt, nitrate, phosphate and organic salt of an M1 element, and
the M2 source is one type or two or more types selected from the group consisting of a sulfate, halide salt, nitrate, phosphate and organic salt of an M2 element.

4. The method for producing a positive electrode active material for a lithium secondary battery according to claim 1, wherein the Li source is one type or two or more types selected from the group consisting of LiOH, Li₂CO₃, CH₃COOLi and (COOLi)₂.

5. The method for producing a positive electrode active material for a lithium secondary battery according to claim 1, wherein the phosphoric acid source is one type or two or more types selected from the group consisting of H₃PO₄, HPO₃, (NH₄)₃PO₄, (NH₄)₂PO₄, NH₄H₂PO₄ and organic phosphates.

6. A method for producing a positive electrode active material for a lithium secondary battery, wherein a carbon material is adhered to the surface of the shell layer by mixing a carbon source with the positive electrode active material for a lithium secondary battery obtained according to the production method described in claim 1, and heating this mixture in an inert gas atmosphere or reducing atmosphere.

7. The method for producing a positive electrode active material for a lithium secondary battery according to claim 6, wherein one or more types of any of sucrose, lactose, ascorbic acid, 1,6-hexanediol, polyethylene glycol, polyethylene oxide, carboxymethyl cellulose, carbon black and filamentous carbon are used as the carbon source.
